(19) United States
(12) Patent Application Publication
(10) Pub. No.: US 2022/0205306 A1
(43) Pub. Date: Jun. 30, 2022

(54) OPENING AND CLOSING BODY CONTROL APPARATUS OF VEHICLE

(71) Applicant: Mazda Motor Corporation, Hiroshima (JP)

(72) Inventors: Hirokazu YAMAUCHI, Aki-gun (JP); Hideaki FUJII, Aki-gun (JP)

(73) Assignee: Mazda Motor Corporation, Hiroshima (JP)

(21) Appl. No.: 17/510,389

(22) Filed: Oct. 26, 2021

(30) Foreign Application Priority Data
Dec. 24, 2020 (JP) 2020-215007

(51) Int. Cl. E05F 15/73; E05F 15/40

(52) U.S. Cl. CPC E05F 15/73; E05F 15/40; E05F 2015/767; E05Y 2201/434; E05Y 2400/36; B60J 5/04; E05Y 2400/44; E05Y 2400/54; E05Y 2400/858; E05Y 2900/546; E05Y 2400/40

(57) ABSTRACT

An opening and closing body controller for controlling an opening and closing body that opens and closes an opening of a vehicle body includes driving means that drives the opening and closing body to open and close, user detection means that detects whether a predetermined motion is performed by a user when a distance between the user and the opening and closing body is within a predetermined range, and control means. The control means is configured to, when the user detection means detects the predetermined motion of the user, control the driving means so that the opening and closing body opens and closes at a first speed if the distance between the user and the opening and closing body is within the predetermined range, and so that the opening and closing body opens and closes at a second speed if the distance is out of the predetermined range.

### CROSS-REFERENCE TO RELATED APPLICATION

The present application claims priority to Japanese Patent Application 2020-215007, filed Dec. 24, 2020, the entire contents of which are incorporated herein by reference.

### BACKGROUND

### Field

The present disclosure relates to control of an opening and closing body of a vehicle.

### Description of the Related Art

It has been known that, as a result of detection of a foot of a user having been put under a rear bumper of a vehicle, an opening and closing body such as a trunk lid is caused to operate to open (see Patent Literature 1). In such an apparatus, in order to avoid contact between the user and the opening and closing body, the opening and closing speed of the opening and closing body is set to be slower than that of the manual opening and closing.

There has been known an automatic opening and closing apparatus of a vehicle body door for changing an opening and closing speed of an opening and closing body according to a position of a specific form terminal possessed by a user (see Patent Literature 2). In such an apparatus, for example, the opening and closing speed is set to be slower when the portable terminal is present within a passing range of the vehicle body door. On the other hand, the opening and closing speed is set to be faster when the portable terminal is absent within the passing range of the vehicle body door.

### CITATION LIST

### Patent Literature

[Patent Literature 1] Japanese Patent Laid-Open No. 2001-234653
[Patent Literature 2] Japanese Patent Laid-Open No. 2019-31873

### SUMMARY

### Technical Problems

In the invention of Patent Literature 1, the user needs to approach the opening and closing body for putting his or her foot under the rear bumper of the vehicle; accordingly, there is a concern about contact with the opening and closing body that opens and closes. Furthermore, in the invention of Patent Literature 2, the user needs to possess the specific portable terminal.

The present disclosure has been made in view of the above matter, and an object of the present disclosure is to, without using a tool such as a portable terminal, reliably suppress contact of an opening and closing body with a user and reduce as much as possible a waiting time taken to open and close the opening and closing body.

### Means for Solving the Problems

In order to achieve the above object, the present disclosure changes an opening and closing speed of an opening and closing body according to a distance between a user and the opening and closing body.

Specifically, an opening and closing body control apparatus disclosed herein is an opening and closing body control apparatus of a vehicle for controlling a hinged door-type opening and closing body that opens and closes an opening of a vehicle body, which is characterized by including driving means that drives the opening and closing body to open and close, user detection means that detects whether a predetermined motion is performed by a user when a distance between the user and the opening and closing body is within a predetermined range, and control means that controls the driving means, and the opening and closing body control apparatus is characterized in that when the user detection means detects the predetermined motion of the user, the control means controls the driving means so that the opening and closing body opens and closes at a first speed if the distance between the user and the opening and closing body is within the predetermined range, and so that the opening and closing body opens and closes at a second speed if the distance is out of the predetermined range, and the second speed is larger than the first speed.

According to this, it is configured so that the opening and closing speed of the opening and closing body that is driven to open and close changes according to the distance between the user and the opening and closing body. Thus, when the user is present within the predetermined range with a possibility of contacting the opening and closing body, the opening and closing speed of the opening and closing body is made slower, so that contact between the user and the opening and closing body can be suppressed. On the other hand, when the user is present out of the predetermined range with no possibility of contacting the opening and closing body, the opening and closing speed of the opening and closing body is made faster, so that the time in which the user waits for opening and closing of the opening and closing body decreases and the stress the user feels can be reduced.

Preferably, the opening and closing body driving apparatus of the vehicle includes a switch for opening and closing the opening and closing body, and switch operation detection means that detects an operation of the switch, and when the switch operation detection means detects the operation of the switch, the control means controls the driving means so that the opening and closing body opens and closes at the first speed.

With this configuration, when the user performs the switch operation, it is likely that the user is present within the predetermined range; accordingly, the speed of the opening and closing body is made slower, so that contact between the user and the opening and closing body can be suppressed.

The opening and closing body driving apparatus of the vehicle is characterized in that the opening is provided at a rear face of the vehicle body, the opening and closing body is a back door provided at a rear portion of the vehicle body, and the user detection means is provided at a rear face of the back door.

With this configuration, an obstacle hardly occurs between the user and the back door, and the motion performed by the user can be detected reliably.

Preferably, the opening and closing body control apparatus of the vehicle includes obstacle detection means that detects whether an obstacle is present within an opening operation range of the back door, and when the obstacle is detected, the control means stops an opening operation of the opening and closing body that is caused by the driving means.

With this configuration, contact between the opening and closing body and the obstacle can be prevented at the time of the opening operation of the opening and closing body.

The opening and closing body control apparatus is characterized in that an average speed of the first speed is 300 mm/s to 400 mm/s, and an average speed of the second speed is 450 mm/s to 550 mm/s.

With this configuration, while contact between the user and the opening and closing body is suppressed, a speed appropriate for reducing the waiting time in which the user waits for opening and closing of the opening and closing body can be set.

The opening and closing body control apparatus of the vehicle is characterized by including image capturing means that captures an image of the predetermined range, wherein when an obstacle is detected within the predetermined range based on the image obtained by the image capturing means, the control means stops opening and closing of the opening and closing body that is caused by the driving means.

In this way, presence or absence of the obstacle within the predetermined range is detected based on the captured image, so that contact between the opening and closing body and the obstacle within the predetermined range can be avoided reliably.

### Advantages

According to the present disclosure, it is possible to achieve the opening and closing body control apparatus of the vehicle that changes the opening and closing speed of the opening and closing body according to the distance between the user and the opening and closing body and reduces the waiting time in which the user waits for opening and closing of the opening and closing body while reliably suppressing contact between the user and the opening and closing body.

### BRIEF DESCRIPTION OF THE DRAWINGS

FIG. 1 is a perspective view illustrating a rear face of a vehicle body.

FIG. 2 is a block diagram illustrating a configuration of a control system of an opening and closing body control apparatus of a vehicle.

FIG. 3 is a plan view illustrating a rear portion of the vehicle body in a state in which an opening and closing body is open.

FIG. 4 is a side view illustrating the rear portion of the vehicle body in the state in which the opening and closing body is open.

FIG. 5 is a flowchart illustrating a flow of processing when the opening and closing body control apparatus opens the opening and closing body.

FIG. 6 is a flowchart illustrating a flow of processing when the opening and closing body control apparatus closes the opening and closing body.

FIG. 7 is a graph illustrating a relationship between an opening and closing speed of the opening and closing body and user's perception.

FIG. 8 is a plan view according to another exemplary embodiment.

FIG. 9 is a plan view according to another exemplary embodiment.

FIG. 10 is a side view according to another exemplary embodiment.

FIG. 11 is a plan view according to another exemplary embodiment.

FIG. 12 is a diagram of a computer structure that implements the various circuitry (programmable and discrete) in the computation device according to the various embodiments.

### DESCRIPTION OF EMBODIMENTS

Hereinafter, a mode for carrying out the present disclosure will be described based on the drawings. The following description of a preferred embodiment is merely illustrative in nature and is not intended to limit the present disclosure, applications thereof, or use thereof.

<Basic Configuration of Opening and Closing Body Control Apparatus>

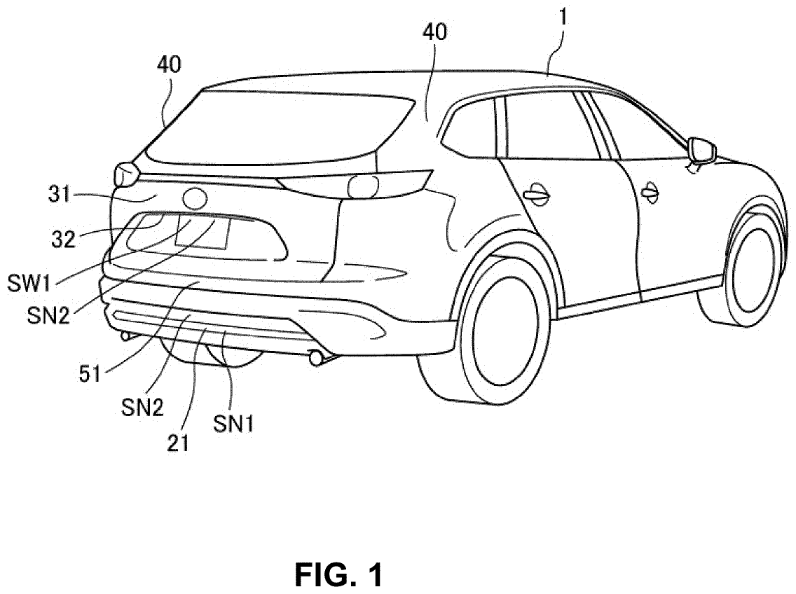

FIG. 1 illustrates a rear face of a vehicle body 1 including an opening and closing body control apparatus 10 of a vehicle according to the present disclosure. An opening 2 that is open to the rear face of the vehicle body and a back door 3 are provided to the vehicle body 1.

A hinge is provided at an end portion of the opening 2 on the upper side (the upper side in the figure). The hinged door-type back door 3 is attached so that the opening 2 can be opened and closed via this hinge.

A rear bumper 21 extending in the vehicle width direction is provided on the lower side (the lower side in the figure) of the opening 2. A bumper sensor SN1 for detecting collision is provided along the rear bumper 21. The bumper sensor SN1 is, for example, a millimeter wave-type sensor.

Door driving units (door drivers) 40 as driving means are provided at both ends of the opening 2 in the vehicle width direction. The door driving units 40 are of a spindle type having a screw, a nut, a door driving motor 41, and a rotation speed sensor SN3. The rotation speed sensor SN3 is a sensor for measuring a rotation speed of the door driving motor 41. The door driving units 40 are configured to be capable of stretching by driving of the door driving motor 41.

One ends of the door driving units 40 are fixed to the respective ends of the opening 2 in the vehicle width direction. The other ends of the door driving units 40 are fixed to respective ends of the back door 3 in the vehicle width direction. The back door 3 is configured to open and close the opening 2 in association with stretch of the door driving units 40.

An emblem 31 is provided at a center portion of the back door 3 on the rear side. A user detection sensor SN2 as user detection means, a camera 32 as image capturing means, and a door open switch SW1 are provided to the emblem 31. A millimeter wave radar is used as the user detection sensor SN2. The user detection sensor SN2 is set so that the front side behind the back door 3 falls within a detection range. The camera 32 is a camera for a back guide monitor and captures an image of the front side behind the back door 3. The door open switch SW1 is a switch for inputting an instruction for an opening operation of the back door 3.

A latch device 5 and a door close switch SW2 are provided on the lower side of the back door 3. The latch device 5 is a member for locking the back door 3 so that the back door 3 does not open when the back door 3 closes the opening 2. The latch device 5 has a latch portion 51 and a latch motor 52. By driving of the latch motor 52, the latch portion 51 can be switched between a closed state in which the back door 3 is locked and an open state in which the back door 3 is not locked. The door close switch SW2 is a switch for a closing operation of the back door 3.

<Configuration of Door Controller>

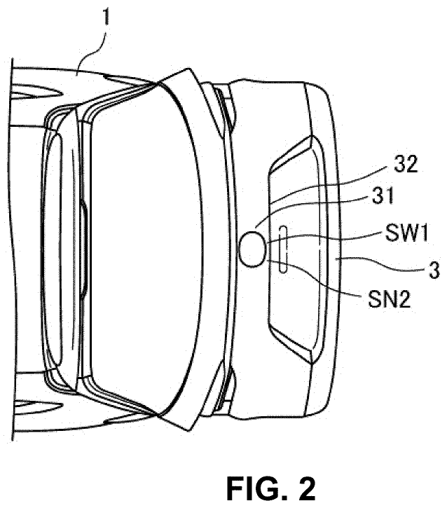

As illustrated in FIG. 2, the opening and closing body control apparatus 10 includes a door controller control unit (CU) (door control circuitry) based on a microcomputer which serves as a controller for controlling opening and closing driving of the back door 3. The door controller CU (Control Unit) has a CPU (Central Processing Unit) that executes a computer program, and a memory including RAM (Random Access Memory) and ROM (Read Only Memory) that store computer programs and data. As used herein, the term “circuitry” may be one or more circuits that optionally include programmable circuitry.

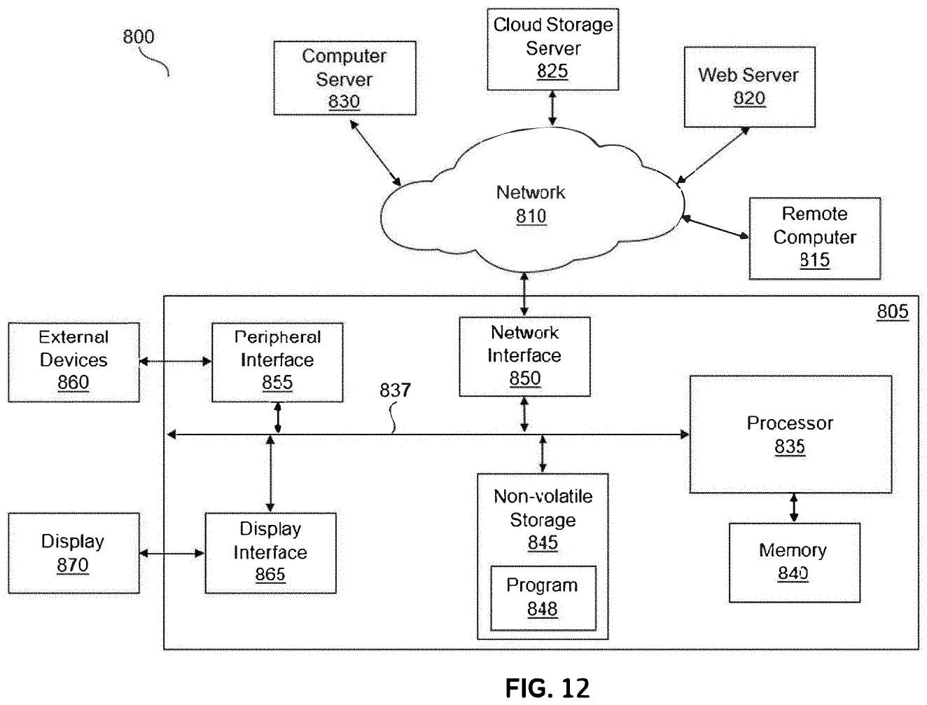

FIG. 12 illustrates a block diagram of a computer that may implement the various embodiments described herein (e.g., the door control circuitry.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 12 is a functional block diagram illustrating a networked system 800 of one or more networked computers and servers. In an embodiment, the hardware and software environment illustrated in FIG. 12 may provide an exemplary platform for implementation of the software and/or methods according to the present disclosure.

Referring to FIG. 12, a networked system 800 may include, but is not limited to, computer 805, network 810, remote computer 815, web server 820, cloud storage server 825 and computer server 830. In some embodiments, multiple instances of one or more of the functional blocks illustrated in FIG. 12 may be employed.

Additional detail of computer 805 is shown in FIG. 12. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm. Bus 837 may be a proprietary or industry standard high-speed parallel or serial peripheral interconnect bus, such as ISA, PCI, PCI Express (PCI-e), AGP, and the like. Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

The door controller CU is electrically connected to various sensors via a bus. Specifically, the door controller CU is connected to the camera 32 and the user detection sensor SN2. Information about a user's motion and information about a distance of a user and an obstacle to the back door 3 which are detected by the camera 32 and the user detection sensor SN2 are transmitted to the door controller CU as signals.

The door controller CU is electrically connected to the camera 32 via a bus. An image captured by the camera 32 is transmitted to the door controller CU. The door controller CU analyzes this image and performs various kinds of determination. Thus, the door controller CU functions as image capturing detection means.

The door controller CU is electrically connected to various switches via a bus. Specifically, the door controller CU is connected to the door open switch SW1 and the door close switch SW2. When the door open switch SW1 and the door close switch SW2 are operated, the fact that these have been operated is transmitted to the door controller CU as a signal. Thus, the door controller CU functions as switch operation detection means that detects the operations of the door open switch SW1 and the door close switch SW2.

The door controller CU performs various kinds of determination and control of the door driving unit 40 and the latch device 5 based on input information from the bumper sensor SN1, the user detection sensor SN2, the camera 32, the door open switch SW1, and the door close switch SW2.

The door controller CU is connected to the door driving unit 40 via a bus. Specifically, the door controller CU is electrically connected to the door driving motor 41 of the door driving unit 40 and the rotation speed sensor SN3. The door controller CU measures the rotation speed of the door driving motor 41 using the rotation speed sensor SN3. The door controller CU transmits a control signal to the door driving motor 41 of the door driving unit 40. Thus, the door controller CU controls the door driving unit 40 based on the rotation speed of the door driving motor 41.

The door controller CU is electrically connected to the latch device 5 via a bus. The door controller CU transmits a control signal to the latch motor 52 of the latch device 5. Thus, the latch motor 52 is driven, and the latch device 5 is switched between the open state and the closed state.

The memory of the door controller CU stores a predetermined motion for driving the back door 3 to open and close. As this predetermined motion, specifically, a kick motion is stored. The kick motion is a motion in which a stopped user swings up his or her single leg and then swings down the single leg which has been swung up. The door controller CU performs determination of presence or absence of the kick motion of the user based on the motion information transmitted from the user detection sensor SN2. When the kick motion of the user is detected by the user detection sensor SN2, the door controller CU controls the door driving unit 40 in order to drive the back door 3 to open and close.

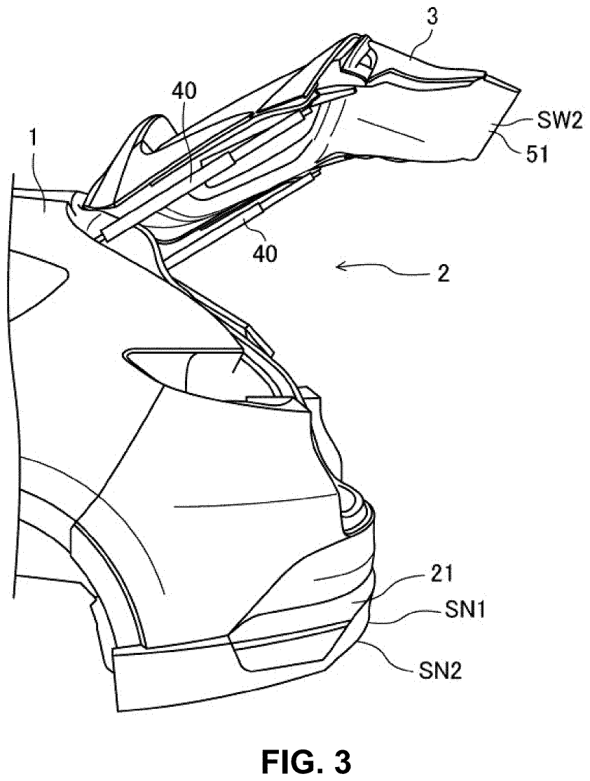

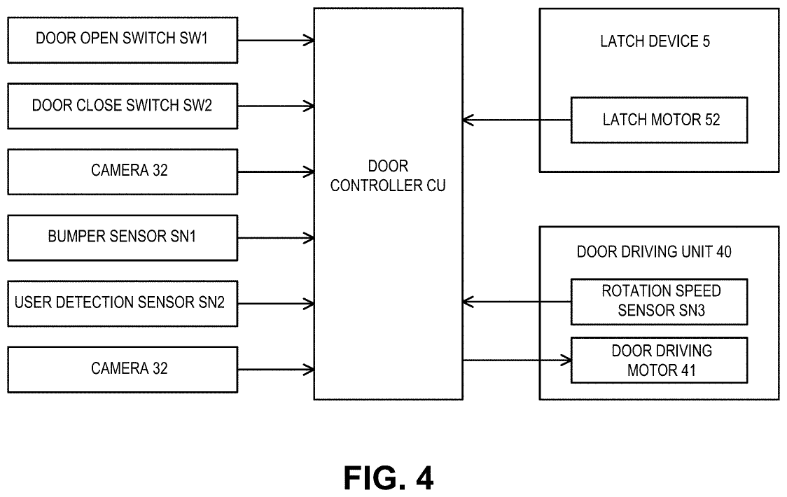

The memory of the door controller CU stores a predetermined range. This predetermined range is set to the front side behind the back door 3. The predetermined range is set to include a range through which the back door 3 passes at the time of opening and closing. Specifically, the predetermined range is set to a range about 2 meters away from a position at which the opening and closing body illustrated in FIGS. 3 and 4 is brought into a state of protruding the most from the vehicle body in the opening and closing operation.

The memory of the door controller CU stores a second predetermined range. This second predetermined range is set to an opening operation range of the opening and closing body (a passing range at the time of the opening operation).

The door controller CU performs determination of whether the user or the obstacle is present within the predetermined range and the second predetermined range, based on the input information from the user detection sensor SN2 or the camera 32. The door controller CU controls the door driving unit 40 in order to control opening and closing driving of the back door 3 based on this determination.

The memory of the door controller CU stores an opening and closing speed of the back door 3. As this opening and closing speed, a slow first speed and a fast second speed are stored. Specifically, an average speed of the first speed, the first speed is 300 mm/s to 400 mm/s, and an average speed of the second speed is 450 mm/s to 550 mm/s. Furthermore, the door controller CU stores a rotation speed of the door driving motor 41 when the opening and closing speed of the back door 3 is the first speed or the second speed. The door controller CU controls output of the door driving motor 41 of the door driving unit 40 based on these.

<Control of Opening and Closing Body Control Apparatus>

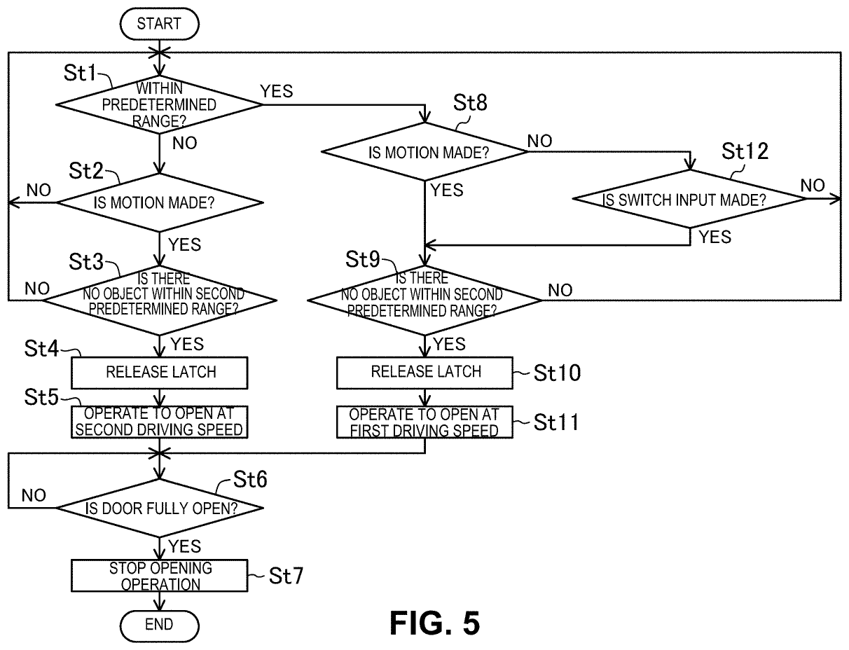

Next, control of the opening and closing body control apparatus 10 will be described. FIG. 5 illustrates a control procedure performed by the door controller CU when the opening and closing body control apparatus 10 opens the back door 3.

In step St1, the door controller CU reads the distance between the user and the back door 3 based on the input information from the user detection sensor SN2. The door controller CU determines whether the user is present within the predetermined range stored in the memory in advance. When it is determined that the user is present, the door controller CU advances the process to St8. When it is determined that the user is absent, the door controller CU advances the process to St2.

In step St2, the door controller CU reads the motion of the user based on the input information from the user detection sensor SN2. The door controller CU determines the presence or absence of the kick motion of the user. When it is determined that the kick motion is made, the door controller CU advances the process to step St3. When it is determined that the kick motion is not made, the door controller CU returns the process to step St1.

In step St3, the door controller CU determines whether the obstacle is present within the second predetermined range, based on the input information from the user detection sensor SN2. When it is determined that the obstacle is absent, the door controller CU advances the process to St4. When it is determined that the obstacle is present, the door controller CU returns the process to step St1.

In step St4, the door controller CU transmits a signal to the latch motor 52 of the latch device 5. Based on this signal, the latch motor 52 is driven so that the latch portion 51 is brought into the open state.

In step St5, the door controller CU transmits a signal to the door driving motor 41 of the door driving unit 40. The door controller CU drives the door driving motor 41 so that the back door 3 operates to open at the second speed, based on the information from the rotation speed sensor SN3.

In step St6, the door controller CU determines whether the back door 3 is fully open. When it is determined that the back door 3 is in the fully open state, the door controller CU advances the process to step St7. When it is determined that the back door 3 is not in the fully open state, the door controller CU returns the process to step St5.

In step St7, the door controller CU stops the opening operation of the back door 3. For this, the door controller CU stops the driving of the door driving motor 41 of the door driving unit 40.

In step St8, the door controller CU reads the motion of the user based on the input information from the user detection sensor SN2. The door controller CU determines the presence or absence of the kick motion of the user. When it is determined that the kick motion is made, the door controller CU advances the process to step St10. When it is determined that the kick motion is not made, the door controller CU advances the process to step St12.

In step St9, the door controller CU determines whether the obstacle is present within the second predetermined range, based on the input information from the user detection sensor SN2. When it is determined that the obstacle is absent, the door controller CU advances the process to St10. When it is determined that the obstacle is present, the door controller CU returns the process to step St1.

In step St10, the door controller CU transmits a signal to the latch motor 52 of the latch device 5. Based on this signal, the latch motor 52 is driven so that the latch portion 51 is brought into the open state.

In step St11, the door controller CU transmits a signal to the door driving motor 41 of the door driving unit 40. The door controller CU drives the door driving motor 41 so that the back door 3 operates to open at the first speed, based on the information from the rotation speed sensor SN3.

In step St12, the door controller CU determines whether the door open switch SW1 of the back door 3 is input (i.e., activated). When the door open switch SW1 is input, the door controller CU advances the process to step St10. When the door open switch SW1 is not input, the door controller CU returns the process to step St1.

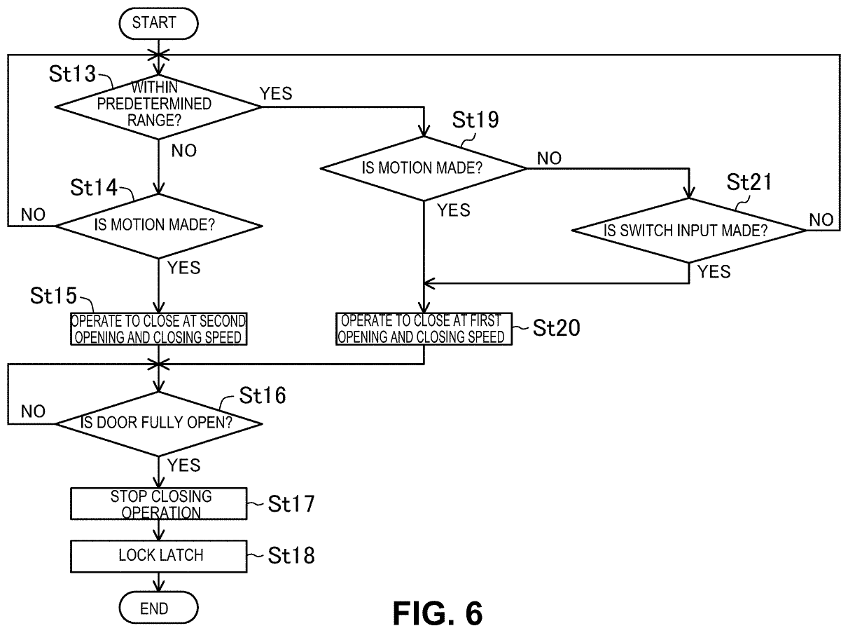

FIG. 6 illustrates a control procedure performed by the door controller CU when the opening and closing body control apparatus 10 closes the back door 3. At this time, the user detection sensor SN2 is provided in the vicinity of the back door, for example, around the rear bumper 21 or a tail lamp.

In step St13, the door controller CU reads the distance between the user and the back door 3 based on the input information from the user detection sensor SN2. The door controller CU determines whether the user is present within the predetermined range stored in the memory in advance. When it is determined that the user is present, the door controller CU advances the process to St19. When it is determined that the user is absent, the door controller CU advances the process to St14.

In step St14, the door controller CU reads the motion of the user based on the input information from the user detection sensor SN2. The door controller CU determines the presence or absence of the kick motion of the user. When it is determined that the kick motion is made, the door controller CU advances the process to step St15. When it is determined that the kick motion is not made, the door controller CU returns the process to step St13.

In step St15, the door controller CU transmits a signal to the door driving motor 41 of the door driving unit 40. The door controller CU drives the door driving motor 41 so that the back door 3 operates to open at the second speed, based on the information from the rotation speed sensor SN3.

In step St16, the door controller CU determines whether the back door 3 is fully closed. When it is determined that the back door 3 is in the fully closed state, the door controller CU advances the process to step St17. When it is determined that the back door 3 is not in the fully closed state, the door controller CU repeats step St16.

In step St17, the door controller CU stops the closing operation of the back door 3. For this, the door controller CU stops the driving of the door driving motor 41 of the door driving unit 40.

In step St18, the door controller CU transmits a signal to the latch motor 52 of the latch device 5. Based on this signal, the latch motor 52 is driven so that the latch portion 51 is brought into the closed state.

In step St19, the door controller CU reads the motion of the user based on the input information from the user detection sensor SN2. The door controller CU determines the presence or absence of the kick motion of the user. When it is determined that the kick motion is made, the door controller CU advances the process to step St20. When it is determined that the kick motion is not made, the door controller CU advances the process to step St21.

In step St20, the door controller CU transmits a signal to the door driving motor 41 of the door driving unit 40. The door controller CU drives the door driving motor 41 so that the back door 3 operates to open at the first speed, based on the information from the rotation speed sensor SN3.

In step St21, the door controller CU determines whether the door close switch SW2 of the back door 3 is input. When the door close switch SW2 is input, the door controller CU advances the process to step St20. When the door close switch SW2 is not input, the door controller CU returns the process to step St13.

<Operation of Opening and Closing Body Control Apparatus>

An operation of the opening and closing body control apparatus 10 when the back door 3 closes the opening 2 will be described. When the back door 3 is closed, the back door 3 starts the opening operation at the first speed if the kick motion performed by the user within the predetermined range is detected by the user detection sensor SN2. When the door open switch SW1 is input, the back door 3 also starts the opening operation at the first speed. On the other hand, when the kick motion performed by the user out of the predetermined range is detected by the user detection sensor SN2, the back door 3 starts the opening operation at the second speed.

The back door 3 that operates to open detects presence or absence of the obstacle within the second predetermined range by the user detection sensor SN2 provided on the back door 3. Thus, the user detection sensor SN2 functions as obstacle detection means (obstacle detection circuitry). When it is detected by the user detection sensor SN2 that the obstacle is present within the second predetermined range, the back door 3 stops the opening operation. When it is not detected that the obstacle is present, the back door 3 operates to fully open.

An operation of the opening and closing body control apparatus 10 when the back door 3 opens the opening 2 will be described. When the back door 3 is open, the back door 3 starts the closing operation at the first speed if the kick motion performed by the user within the predetermined range is detected by the user detection sensor SN2 provided in the vicinity of the opening 2. When the door close switch SW2 is input, the back door 3 also starts the closing operation at the first speed. On the other hand, when the kick motion performed by the user out of the predetermined range is detected by the user detection sensor SN2, the back door 3 starts the closing operation at the second speed.

<Effects of Opening and Closing Body Control Apparatus>

Accordingly, in the above embodiment, the back door 3 can be driven by the user performing the kick motion. Therefore, the user can open and close the back door 3 even when, for example, he or she holds baggage and his or her hands are thus not free.

In the above embodiment, when the user and the back door 3 are close to each other, that is, when the user within the predetermined range performs the kick motion or operates the switch SW1 or SW2, the back door 3 is driven to open and close at the slow first speed. Therefore, contact between the user and the back door 3 is suppressed.

On the other hand, when the user and the back door are far from each other, that is, when the user out of the predetermined range performs the kick motion, the back door 3 is driven to open and close at the fast second speed. Therefore, the time required for the opening and closing of the back door 3 decreases, reducing the stress applied to the user waiting for the opening and closing.

In the above exemplary embodiment, when the user detection sensor SN2 detects the obstacle during the opening operation of the back door 3, the back door 3 stops the opening operation. Therefore, contact of the back door 3 that operates to open with the obstacle such as, specifically, a ceiling of a parking lot is suppressed.

In the above embodiment, the average speed of the first speed of the back door 3 is set to 300 mm/s to 400 mm/s, and the average speed of the second speed of the back door 3 is set to 450 mm/s to 550 mm/s.

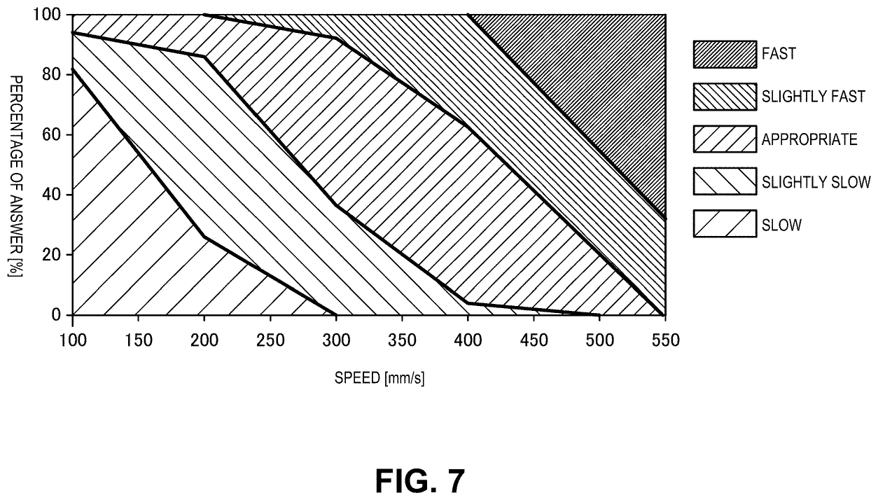

FIG. 7 illustrates a relationship between a speed of the back door 3 and a user's feeling about the speed. As illustrated in FIG. 7, the first speed is a speed at which 60 to 90% of people feel appropriate, slightly slow, or slow. On the other hand, the second speed is a speed at which about 30% of people feel too fast. Therefore, the second speed is a speed which is not normally set.

Accordingly, even when the user is present near the back door 3, the back door 3 can be opened and closed safely. Furthermore, when the back door 3 and the user are away from each other, the back door 3 can be opened and closed at the fast speed which is not normally set. Thus, the waiting time in which the user waits for the opening and closing of the back door 3 can be reduced.

### Other Embodiments

In the above exemplary embodiment, the bumper sensor SN1 is a millimeter wave-type sensor. However, as the bumper sensor SN1, a sonar-type sensor, for example, may be used.

In the above exemplary embodiment, the image captured by the camera 32 is transmitted to the door controller CU, and the door controller CU analyzes this image to perform various kinds of determinations. However, the image captured by the camera 32 is transmitted to an ECU different from the door controller CU, and the ECU analyzes this image to perform various kinds of determinations. Results of the analysis and various kinds of determinations which are performed by this ECU may be transmitted to the door controller CU.

In the above exemplary embodiment, the predetermined range is photographed by the camera 32. When it is detected by the camera 32 that the obstacle is present within the predetermined range, the back door 3 may stop the opening and closing driving.

In the above exemplary embodiment, the control procedure performed by the door controller CU includes step St2 after step St1. However, the order of step St1 and step St2 may be reversed.

In the above exemplary embodiment, the control means may include a user recognition unit (user recognition circuitry) that receives a signal from a smart key and recognizes that the user who has performed the kick motion is a specific user (vehicle owner). At this time, based on the signal from the smart key, the user recognition unit recognizes that the user who possesses the smart key is the specific user. When the kick motion of the specific user recognized by the user recognition unit is detected, the opening and closing control of the back door 3 may be performed.

Although in the above exemplary embodiment, the motion of the user is the kick motion, not limited to the kick motion, as long as it is a motion using legs, operations and effects similar to those described above can be provided. Furthermore, a motion using a section other than legs may be a predetermined motion.

Although in the above exemplary embodiment, one door driving unit 40 is provided at each of both ends of the opening 2 in the vehicle width direction, one door driving unit 40 may be provided at either one of the ends.

In the above exemplary embodiment, the user detection sensor SN2 in which the distance detection means and the user detection means are integrated is provided. However, the distance detection means and the user detection means may be provided separately.

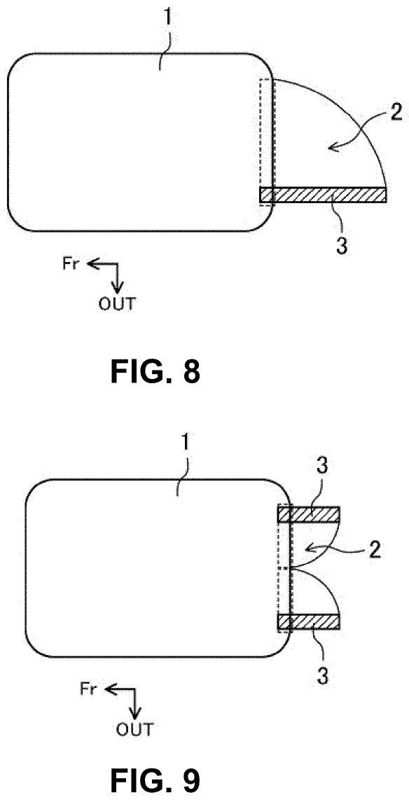

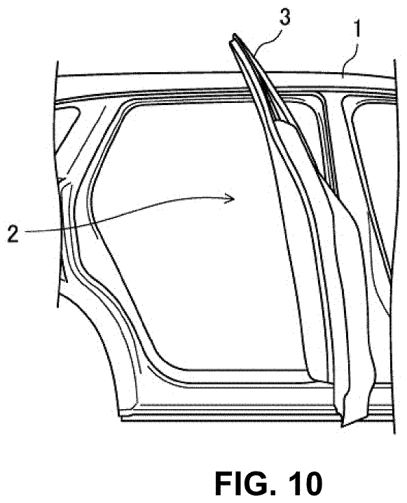

In the above exemplary embodiment, the hinge is provided at the end of the opening 2 on the upper side. However, as illustrated in FIG. 8, the hinge may be provided at an end portion of the opening 2 in the vehicle width direction. Alternatively, as illustrated in FIG. 9, the hinge may be provided so as to provide a clamshell door.

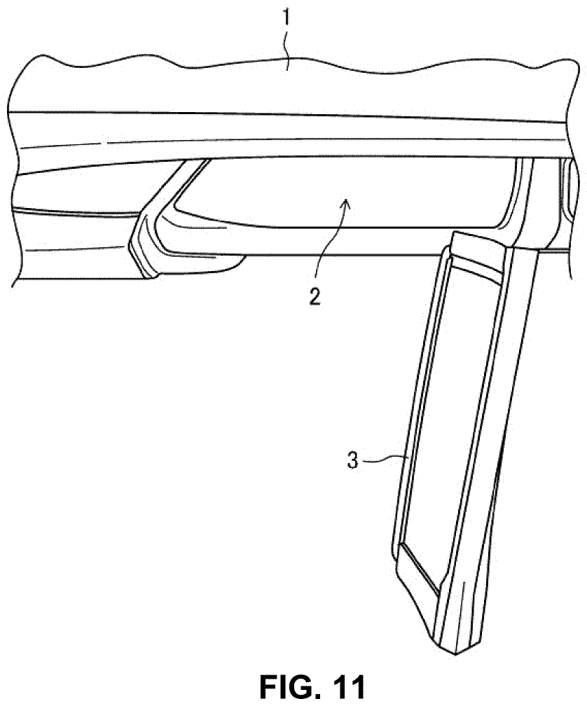

Although in the above exemplary embodiment, the opening 2 and the back door 3 as the opening and closing body are provided at a rear portion of the vehicle body, they may be provided at a side portion of the vehicle body as illustrated in FIGS. 10 and 11. At this time, the opening and closing body is a door for occupants. Furthermore, the predetermined range is a range with a possibility of contacting the door for occupants that is driven to open and close on the vehicle body lateral side.

### INDUSTRIAL APPLICABILITY

The present disclosure can reduce the waiting time relating to the opening and closing while reliably suppressing contact between the opening and closing body and the user, and thus is extremely useful.

### REFERENCE SIGNS LIST

1 vehicle body
2 opening
3 back door
32 camera
40 door driving unit
10 opening and closing body control apparatus
SN1 bumper sensor
SN2 user detection sensor
SN3 rotation speed sensor

1. An opening and closing body control apparatus for controlling a hinged door-type opening and closing body that opens and closes an opening of a vehicle body, the opening and closing body control apparatus comprising:
a driver that drives the opening and closing body to open and close;
a user detector that detects whether a predetermined motion is performed by a user when a distance between the user and the opening and closing body is within a predetermined range; and
control circuitry that controls the driver, wherein
when the user detector detects the predetermined motion of the user, the control circuitry controls the driver so that the opening and closing body opens and closes at a first speed if the distance between the user and the opening and closing body is within the predetermined range, and so that the opening and closing body opens and closes at a second speed if the distance is out of the predetermined range, and
the second speed is larger than the first speed.

2. The opening and closing body control apparatus of according to claim 1, further comprising:
a switch for opening and closing the opening and closing body; and
a switch operation detector that detects an operation of the switch, wherein
when the switch operation detector detects the operation of the switch, the control circuitry controls the driver so that the opening and closing body opens and closes at the first speed.

3. The opening and closing body control apparatus according to claim 2, wherein
the opening of the vehicle body is provided at a rear face of the vehicle body,
the opening and closing body is a back door provided at a rear portion of the vehicle body, and
the user detector is provided at a rear face of the back door.

4. The opening and closing body control apparatus according to claim 3, further comprising:
an obstacle detector that detects whether an obstacle is present within an opening operation range of the back door, wherein
when the obstacle is detected, the control circuitry stops an opening operation of the opening and closing body that is caused by the driver.

5. The opening and closing body control apparatus according to claim 4, wherein an average speed of the first speed is 300 mm/s to 400 mm/s, and an average speed of the second speed is 450 mm/s to 550 mm/s.

6. The opening and closing body control apparatus according to claim 5, further comprising:
an image capturer that captures an image of the predetermined range, wherein
when an obstacle is detected within the predetermined range based on the image obtained by the image capturer, the control circuitry stops opening and closing of the opening and closing body that is caused by the driver.

7. The opening and closing body control apparatus according to claim 1, wherein
the opening of the vehicle body is provided at a rear face of the vehicle body,
the opening and closing body is a back door provided at a rear portion of the vehicle body, and
the user detector is provided at a rear face of the back door.

8. The opening and closing body control apparatus according to claim 1, wherein an average speed of the first speed is 300 mm/s to 400 mm/s, and an average speed of the second speed is 450 mm/s to 550 mm/s.

9. The opening and closing body control apparatus according to claim 1, further comprising:
an image capturer that captures an image of the predetermined range, wherein
when an obstacle is detected within the predetermined range based on the image obtained by the image capturer, the control circuitry stops opening and closing of the opening and closing body that is caused by the driver.

10. The opening and closing body control apparatus according to claim 2, wherein an average speed of the first speed is 300 mm/s to 400 mm/s, and an average speed of the second speed is 450 mm/s to 550 mm/s.

11. The opening and closing body control apparatus according to claim 2, further comprising:
an image capturer that captures an image of the predetermined range, wherein
when an obstacle is detected within the predetermined range based on the image obtained by the image capturer, the control circuitry stops opening and closing of the opening and closing body that is caused by the driver.

12. The opening and closing body control apparatus according to claim 7, further comprising:
an obstacle detector that detects whether an obstacle is present within an opening operation range of the back door, wherein
when the obstacle is detected, the control circuitry stops an opening operation of the opening and closing body that is caused by the driver.

13. The opening and closing body control apparatus according to claim 7, wherein an average speed of the first speed is 300 mm/s to 400 mm/s, and an average speed of the second speed is 450 mm/s to 550 mm/s.

14. The opening and closing body control apparatus according to claim 7, further comprising:
an image capturer that captures an image of the predetermined range, wherein
when an obstacle is detected within the predetermined range based on the image obtained by the image capturer, the control circuitry stops opening and closing of the opening and closing body that is caused by the driver.

15. The opening and closing body control apparatus according to claim 8, further comprising:
an image capturer that captures an image of the predetermined range, wherein
when an obstacle is detected within the predetermined range based on the image obtained by the image capturer, the control circuitry stops opening and closing of the opening and closing body that is caused by the driver.

16. The opening and closing body control apparatus according to claim 4, wherein the obstacle detector is a user detection sensor.

17. The opening and closing body control apparatus according to claim 1, wherein the obstacle detector is a user detection sensor, and
wherein when the opening and closing body is closed, the control circuitry controls the opening and closing body to open at the first speed if the predetermined motion performed by the user is detected within the predetermined range by the user detection sensor, and
when the opening and closing body is closed, the control circuitry controls the opening and closing body to open at the second speed if the predetermined motion performed by the user is detected to be outside of the predetermined range by the user detection sensor.

18. The opening and closing body control apparatus according to claim 17, further comprising:
a switch for opening and closing the opening and closing body; and
a switch operation detector that detects an operation of the switch, wherein
when the switch operation detector detects the operation of the switch, the control circuitry controls the opening and closing body to open at the first speed.

19. The opening and closing body control apparatus according to claim 1, wherein the obstacle detector is a user detection sensor, and
wherein when the opening and closing body is open, the control circuitry controls the opening and closing body to close at the first speed if the predetermined motion performed by the user is detected within the predetermined range by the user detection sensor, and
when the opening and closing body is open, the control circuitry controls the opening and closing body to close at the second speed if the predetermined motion performed by the user is detected to be outside of the predetermined range by the user detection sensor.

20. The opening and closing body control apparatus according to claim 19, further comprising:
a switch for opening and closing the opening and closing body; and
a switch operation detector that detects an operation of the switch, wherein
when the switch operation detector detects the operation of the switch, the control circuitry controls the opening and closing body to close at the first speed.
